(19) United States
(12) Patent Application Publication
(10) Pub. No.: US 2012/0288349 A1
(43) Pub. Date: Nov. 15, 2012

(54) Container Handling Device, Use of Such a One, and Methods in Unloading and Loading

(76) Inventor: Karl Bohman, Bromma (SE)

(21) Appl. No.: 13/574,812

(22) PCT Filed: Feb. 2, 2011
(86) PCT No.: PCT/SE2011/050108

§ 371 Date: Jul. 24, 2012

(30) Foreign Application Priority Data
Feb. 3, 2010 (SE) 1050107-0

(51) Int. Cl. B60P 1/02; B65G 67/60; B65G 63/00

(52) U.S. Cl. 414/542; 414/803

(57) ABSTRACT

The invention concerns a container handling device for the temporary storage of containers in unloading and loading. The container handling device is arranged to be able to receive at least one pair of container units with one unit in the pair being situated above the other one. The device has a support structure having a loading platform and a transfer device connected with support structure. The transfer device has a grip frame to surround the container unit, which grip frame has inside dimensions so that a movement of a container unit through the same is possible. The invention also concerns a use of the container handling device as well as a method for unloading and loading by the invented container handling device.

### FIELD OF THE INVENTION

The present invention relates to a container handling device for the temporary storage of containers in unloading and loading.

In a second aspect, the invention concerns a use of the invented container handling device.

In a third aspect, the invention concerns methods in unloading and loading, respectively, of cargo containers.

With container in the present application, a cargo container of standardized dimensions is intended, primarily but not exclusively ISO-containers of the type 20 ft×8 ft×8′6′ ft or 40 ft×m 8 ft×8′6′ ft, which have a length of 6.05 m and 12.2 m, respectively, a width of 2.4 m, and a height of 2.6 m. There are also found, though less usual, lengths corresponding to 24, 28, 44, 45, 46, 53 and 58 ft. Accordingly, also these and other container sizes that are standardized, such as High-Cube or SEM-containers, are contained within the concept of cargo containers in the present application.

When containers are unloaded or loaded, it is common to lift several containers together beside each other, e.g., to lift two 20 ft-containers arranged together longitudinally, together they corresponding to approximately one 40 ft-container.

The ISO-containers and normally also other standardized cargo containers are, according to standard, provided with standardized container corners. Each such container corner has a through hole in each one of the three sides of the corner. These corners are intended for different purposes, among others for vertical coupling together of containers stacked on each other and for the attachment of grip devices upon lifting.

With the concept container unit, an individual container that is being unloaded or loaded individually as well as two containers longitudinally arranged together being unloaded or loaded together as one unit is intended.

When a harbour lifting crane unloads or loads, different types of lifts are found. Distinction is made between single lifts, wherein only one container is lifted, twin lifts, wherein two containers are arranged together longitudinally so that they form one container unit, tandem lifts, wherein two containers are arranged together laterally or four containers together both laterally and longitudinally, and vertical tandem lifts, wherein two containers or two pairs of containers arranged together longitudinally are lifted coupled together vertically.

A container handling device according to the present invention may be formed in various ways within the scope of the invention, and may be formed for any one of the types of lifts mentioned above. It may also be adapted so that it manages to handle several of the mentioned kinds of lifts.

### BACKGROUND OF THE INVENTION

In unloading or loading of containers from/to a ship, it is important that the entire unloading/loading process is fast. This entails a logistic problem in view of the fact that the number of containers conveyed by the ship could be very great, in the order of up to 10-15 000 TEU (TEU is a standard measure that denotes twenty-feet equivalents), and in view of each container occupying a considerable volume. In that connection, it is important to avoid that bottlenecks arise and enable that the lifting cranes operate continuously without interruptions.

This means, among other things, that the transportation facilities, usually lorries/trucks, that upon unloading should transport away the containers from the area in the harbour where they are landed by the lifting cranes, most preferably should be available to transport away the container as soon as possible when it is dropped from the lifting crane.

From this point of view, the ideal thing would of course be that, upon completion of a lift, a lorry is in place so that the container is dropped on its platform. Upon next completion of a lift, the lorry should have driven away and an empty one should be in place ready to receive the next container.

Such an ideal timing is hard to achieve in practice, and to let the lorries queuing up in order to allow this entails costs for the idle time of the lorries and requires large space.

A complication is in addition that the containers in the ship transportation, when they are stacked a large number on top of each other, are anchored vertically to each other. For this purpose, there is a hole in each container corner at the top side of the container as well as its underside. A separate locking unit is arranged at each corner, with an upwardly directed component that projects into the hole of the superjacent container and a downwardly directed component that projects into the hole of the subjacent container. The locking units secure the containers stacked on top of each other in the ship transportation. By simple hand grips, each locking unit can be set in the locking and the non-locking state, respectively. There are different designs of such locking units. One example is disclosed in more detail in EP 1 893 508, which hereby is included by reference in the present application.

The complication consists of these locking units having to be removed upon unloading and fitted upon loading, respectively, so-called deconing and coning. In this way, a further handling step is added that makes an optimized timing more difficult.

The difficulties in unloading by completely synchronizing the discharge of the containers with the transportation away of the same as well as the need of removing the locking units usually entails that it is necessary to temporary discharge one or more containers on the ground. From considerations of space, this may not be accepted for more than a few containers. In addition, this requires that the capacity of the lifting crane has to be made use of a second time for lifting over a container from the landing place to the lorry, which decreases the utilization efficiency of the same. Alternatively, separate transhipment cranes may be used.

The problems described above exist of course also when loading a ship.

In order to meet this problem, it is previously known to arrange some kind of intermediate storage platform for the containers that are loaded or unloaded and that cannot be handled immediately by a crane and a lorry, respectively. Examples of such are disclosed in U.S. Pat. No. 6,602,036, U.S. Pat. No. 6,652,211 and U.S. Pat. No. 6,685,418.

In such known platforms, the containers are placed laterally side by side. This creates easily space problems in the harbour terminal. In some cases, this has been solved by elevating the platform so that the lorries can pass under it, which however contributes to it becoming a bulky construction.

In addition, the intermediate storing laterally entails that the lifting devices become fairly complicated, space-requiring and expensive.

Another problem exists in vertical tandem lifts. The fact that containers then are situated on top of each other makes receipt, coning/deconing and transhipment to lorry relatively complicated.

### DESCRIPTION OF THE INVENTION

The object of the present invention is to decrease the handling time of a container in loading or unloading of a ship compared with conventional handling. In that connection, it lies within the scope of this to obviate the disadvantages associated with previously known solutions that are based on the arrangement of a momentarily temporary intermediate storage for the containers.

According to the first aspect of the invention, the object set forth is achieved by a container handling device of the kind indicated by way of introduction having the special features that the container handling device is arranged to be able to receive at least one pair of container units with one unit in the pair being situated above the other one, which container handling device comprises a support structure, a loading platform connected with the support structure and a transfer device connected with the support structure, which transfer device comprises a grip frame arranged to be able to surround at least three of the vertical side was of a container unit and which grip frame has inside dimensions that are greater than the cross-sectional dimensions of a container unit in a horizontal plane so that a vertical movement of a container unit through the grip frame is possible.

It is furthermore desirable to provide an efficient handling of containers that are lifted by vertical tandem lifts.

Thanks to the fact that the container handling device can receive containers on top of each other, they can be intermediately stored with a relatively small space requirement. By the special design of the transfer device, this can be accomplished without limitation of the accessibility to unload a container unit from the container handling device irrespective of where it is situated in the same.

Normally, the container handling device is most suitable for receiving two container units on top of each other. However, also a container handling device that allows three or a plurality of container units on top of each other lies within the scope of the invention.

According to a preferred embodiment, the loading platform is vertically adjustable.

Thereby, organization of the receipt of the container units and unloading of the same from the container handling device are facilitated.

According to a further preferred embodiment, the grip frame is arranged to surround all four vertical sides of a container unit.

Thereby, the frame becomes stable in shape and allows an optimum fastening of the container unit to the transfer device when the container unit is to be unloaded from the container handling device.

According to an additional preferred embodiment, the grip frame is provided with displaceable studs arranged to be insertable into holes situated in corners of the side was of the container unit.

Thereby, the transfer device can, via its grip frame, be directly connected with the container unit without any extra equipment. This results in a reliable and distinct grip that facilitates the handling when the container unit is lifted by the transfer device. The risk of incorrect coupling becomes minimal and the function is reliable. In addition, the transfer device becomes simple in its design.

According to an additional preferred embodiment, the studs of the frame are situated at two long sides of the grip frame and arranged to be insertable into holes situated in upper corners in the two long sides of a container unit.

It is favourable from a load-carrying point of view to have the fixing at the long sides by the overhang being minimized. Attachment at the top gives the best stability.

According to an additional preferred embodiment, the number of studs on each long side is two or four.

This means an expedient adaptation to the number of holes that exist on each side of a container and wherein only one of the pair of holes at the top or at the bottom, preferably at the top, is utilized.

When the container unit consists of a single container, two studs are enough. A container handling device according to the invention intended only for such an application may accordingly be equipped with two studs on the respective girder of the grip frame.

When the container unit consists of two containers, there is also a pair of holes at the middle of the container unit. It may then be suitable to utilize also these in the lift in order to relieve the interlocking device of the containers. In doing so, the number of studs becomes four on each side. Such a grip frame may naturally be used for lifting only one container.

According to a further embodiment, the support structure comprises a support frame arranged at a height above the loading platform when the loading platform is in its lowermost position, which height exceeds the height of a container unit, which support frame is arranged to be able to surround at least three of the vertical side walls of a container unit and has inside dimensions that are greater than the cross-sectional dimensions of a container unit in a horizontal plane so that a vertical movement of a container unit through the support frame is possible.

Through the support frame, the superjacent container unit can be carried by the support structure of the container handling device without abutting against the lower one. Thereby, it is enabled in a simple way that the lower one can be transferred by the transfer device without being obstructed by the upper one. Thanks to the support frame being greater than a container unit, a container unit can pass vertically through the same so that receipt and lifting away of the container units are facilitated.

According to a further preferred embodiment, also the support frame is provided with displaceable studs arranged to be insertable into holes situated in corners of the two side walls of a container unit.

Thereby, the container unit that is carried by the support frame can be fastened in a simple way with the corresponding advantages that have been described for a grip frame formed in a similar way.

According to an additional preferred embodiment, the container handling device is provided with lock handling means for the detachment and/or fastening of locking devices from/to a container unit situated in the container handling device.

Thereby, the initially described requisite application and the detachment, respectively, of locking devices upon transhipment in a harbour terminal become efficient. Thanks to the container handling device being provided with lock handling means, this sequence can be carried out at the same time as a container unit is in the container handling device, which saves time. By the lock handling means, in addition the need of manual manipulation for this is reduced, with the ensuing increased safety.

According to an additional preferred embodiment, the container handling device is provided with lock transportation means for the transportation of locking devices from and/or to the respective lock handling means.

In this way, the need of someone running around and collecting locking devices from their detachment positions at each corner of each container of the container unit, and the corresponding measure when they are to be fastened, is eliminated. This reduces the need of manual manipulation further and decreases the risk of personal injuries.

Suitably, the transport means is arranged to transport the locking devices to/from a location situated at one short side of the container unit.

According to an additional preferred embodiment, the container handling device is composed of two adjacent sections, each section formed in accordance with the invention, each transfer device being arranged to move a container unit in one section laterally in the direction away from the other section.

It occurs in many harbour terminals that the cranes lift two container units side by side, e.g., two 40 ft containers or four 20 ft containers. By this embodiment of the invention, it is adapted to be able to receive container units also from such so-called tandem lifts. A container handling device of this double design may naturally be used also in single lifts.

Preferably, the container handling device according to the invention is provided at the top with guiding-in flanges at each corner of the same and possibly also at the middle of each long side. This is for facilitating guiding-in of the container unit when it is unloaded from the lifting crane.

Preferably, the container handling device is wheel-carried to be adaptable to changes of the position of the lifting crane as a consequence of changes of the position of the vessel. In addition, it is an advantage that the container handling device in this way can be transferred easily.

The above-mentioned preferred embodiments of the invented container handling device are defined in the claims depending on claim 1. It should be emphasized that additional preferred embodiments naturally may consist of all feasible combinations of the above-mentioned preferred embodiments.

From the second aspect of the invention, the object set forth is achieved by the use of the invented container handling device to receive and forward container units in loading and unloading of such ones, particularly in any one of the preferred embodiments of the container handling device.

Preferably, the use comprises also detachment and/or attachment of locking devices from/to the container units.

From the third aspect of the invention, the object set forth is achieved by a method for unloading of the initially mentioned kind comprising the special measures in steps A-E in mentioned order:
A. placing of a first container unit in container handling device by a vertical unloading,
B. placing of a second container unit straight above the first container unit by a vertical unloading,
C. discharging sideward of the first container unit from container handling device,
D. lowering of the second container unit in the container handling device
E. discharging sideward of the second container unit from the container handling device.

According to a preferred embodiment, the steps A and B are carried out simultaneously by them being unloaded from a vertical tandem lift.

Thereby, the method is adapted to the rationalization gain that is achieved in this type of lift and obviates the problems associated with such a lift.

According to a preferred embodiment of the invented unloading method, step B is carried out so that the second container unit is placed so that it rests on the first one.

According to an additional preferred embodiment, between steps B and C, the following steps are carried out:
B1. elevation of the two container units
B2. retention of the second container unit
B3. lowering of the first container unit.

According to an additional preferred embodiment, the second container device is lowered in step D by means of a loading platform arranged in the container handling device.

From the third aspect of the invention, the object set forth is achieved also by a method for loading of the initially mentioned kind comprising the special measures in steps F-J in mentioned order:
F. charging from the side of a first container unit in the container handling device
G. elevation of the first container unit in the container handling device
H. charging from the side of a second container unit so that it is loaded under the first container unit in the container handling device
I. vertical unloading of the first container unit
J. vertical unloading of the second container unit

According to a preferred embodiment of the loading method, the first container unit is elevated in step G by means of a loading platform arranged in the container handling device.

According to an additional preferred embodiment of the loading method, the first container unit is retained between steps G and H, and the first container unit is lowered between steps H and I until it rests on the second container unit.

According to an additional preferred embodiment in the loading method, the steps I and J take place simultaneously by a vertical tandem lift.

According to an additional preferred embodiment in unloading or loading, locking devices are detached and attached, respectively, from/to each container unit when the container unit is in the container handling device.

According to an additional preferred embodiment, locking devices are transported by lock transportation means from/to locking attachment positions on the container unit.

According to an additional preferred embodiment, the unloading/loading method is exercised by a container handling device according to the present invention, particularly according to any one of the preferred embodiments of the same.

The above-mentioned preferred embodiments of the invented methods are defined in the claims depending on claims 13 and 18, respectively. It should be emphasized that further preferred embodiments of the invented methods may consist of measures that follow from different preferred embodiments of the invented container handling device.

The invented use and the invented methods have advantages corresponding to the ones of the invented container handling device and the preferred embodiments of the same and that have been accounted for above.

The invention is explained in more detail by the subsequent detailed description of embodiment examples of the same, reference being made to the appended drawing figures.

### BRIEF DESCRIPTION OF THE DRAWINGS

FIG. 1 is a schematic illustration of the surroundings of the invention in a harbour terminal.

FIG. 2 is a perspective view of a container handling device according to a first embodiment example of the invention.

FIGS. 3-13 illustrate in order the different steps when the container handling device is used in unloading.

FIG. 14 is a schematic end view of a container handling device according to a second embodiment example.

FIGS. 15 and 16 illustrate schematic handling steps in a container handling device according to a third embodiment example.

### DESCRIPTION OF EMBODIMENT EXAMPLES OF THE INVENTION

The container handling device and how it is used is described in the following, reference being made to different steps in unloading. It should be appreciated that loading takes place in principally the corresponding way, but in a logically different order that essentially is the reversed one.

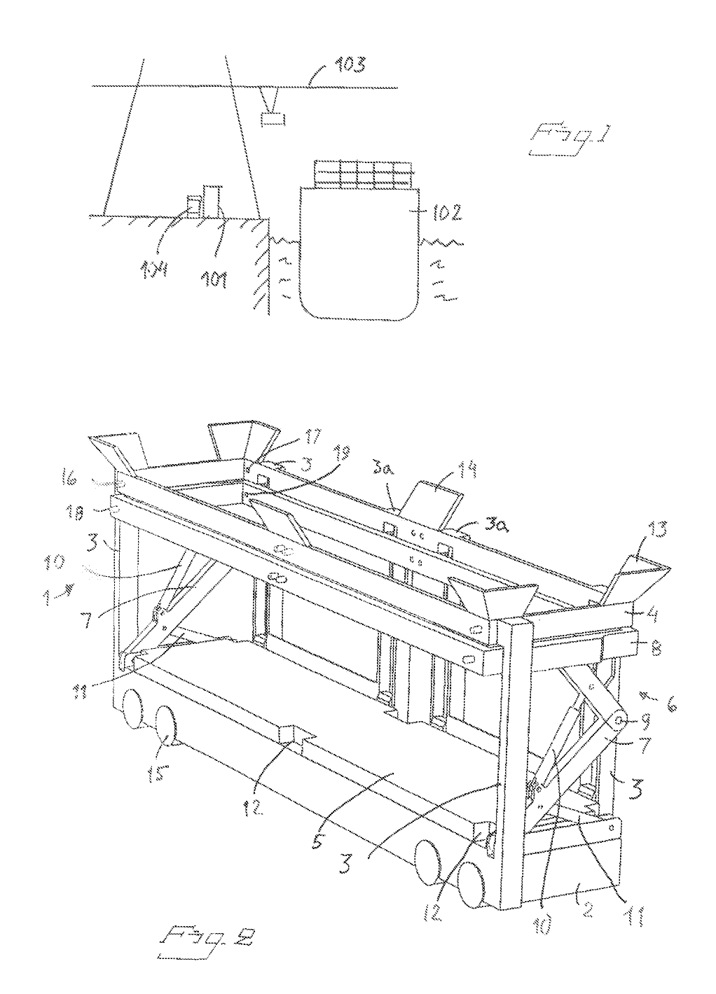

In FIG. 1, there is schematically shown the context in which the container handling device according to the invention is intended to be used.

Containers are unloaded from the ship 102 by means of a crane 103 to be put down in a container handling device 101 according to the invention. From the container handling device, the containers are then transferred to a lorry 104 that has been positioned beside the longitudinal side of the container handling device in order to subsequently be transported away by the lorry.

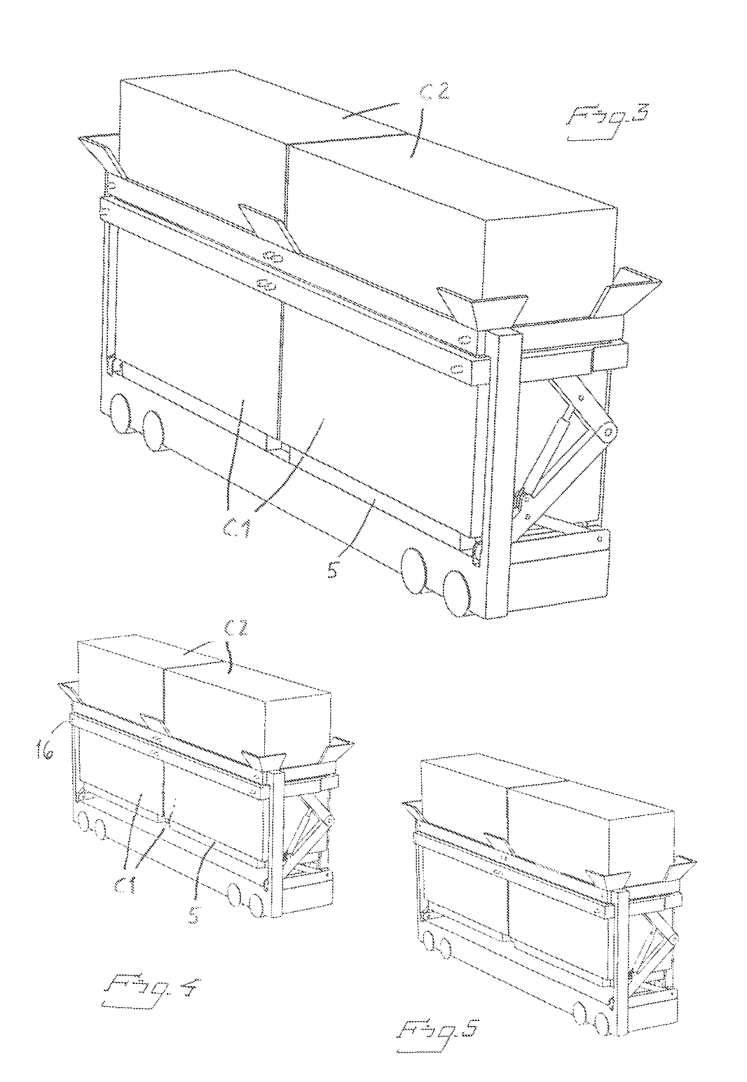

The container handling device is shown in more detail in FIG. 2 that is a perspective view of the same and in the empty state, i.e., before it has received any container. It is box-shaped with a support structure 1 consisting of a bottom part 2, four cornered supporting posts 3 and a rectangular support frame 4 situated at the top. In the example shown, the support structure has also two central supporting posts 3a situated in the vicinity of the middle of one long side. On the bottom part 2, there is a loading platform 5 that is vertically adjustable by a driving device, not shown in more detail, under the same in the bottom part 2. The driving device may be of conventional kind, such as an electric motor or pneumatically or hydraulically operated.

The container handling device is furthermore provided with a transfer device 6 that consists of a link mechanism 7 in each end wall with a rectangular grip frame 8 at the upper end of the link mechanism 7. The link mechanism 7 is articulately connected with the bottom part 2 and with the grip frame 8 and has in addition a joint 9 approximately in the middle. The link mechanism 7 is actuated by hydraulic pistons 10 and 11 by means of which the grip frame 8 can be moved both vertically and horizontally.

The example shown in the figure is intended for a container unit corresponding to two 20 ft containers arranged together longitudinally or a sole 40 ft container. In the following, the function of the container handling device will be described in connection with two 20 ft containers.

The support frame 4 as well as the grip frame 8 has inner dimensions that allow passage of two 20 ft containers between each one of them. Each frame has accordingly an inner length of slightly more than 12.2 m and an inner width of slightly more than 2.5 m, suitably some centimetres or at the top a pair of tens of centimetres longer in each direction. It should be a sufficiently large play between the sides of the container unit and the respective frame so that passage of the container unit becomes problem-free. On the other hand, the play should be as small as possible, particularly in the cross direction for the facilitation of clamping of a container unit to either of the frames 4, 8. A well-judged balance between these needs means that each inside dimension should be in the range of 1-30 cm longer than the corresponding dimension of the container unit, preferably in the range of 5-15 cm.

In the example, the container handling device has a front side and a back side on the respective long side, the central supporting post 3a being situated at its back side. The front side is entirely open and is intended for a container unit to be transferable out or in through the same. The distance between the corner post 3 on the front side is accordingly somewhat greater than the length of the container unit and so that the end wall parts of the transfer device 6 simultaneously have room between the corner pillars in the transfer motion. The distance is accordingly in the order of 12.5-13 m, and the height, i.e., the distance between the loading platform 5 in its lowermost position and the support frame 4, is at least 2.6 m, suitably 2.8-3.5 m.

The loading platform 5 has recesses 12 in each corner and at the middle to give room for the corners of the container unit, in order to facilitate coning and deconing.

The support frame 4 is provided with obliquely outwardly upwardly directed guide plates 13 at an angle in each corner and a plane obliquely outwardly directed guide plate 14 in the middle of each long side. In this way, centring is facilitated when a container unit is lifted down from a crane. Further, the bottom part is provided with wheels 15.

On each girder on the long side of the support frame 4, there are four studs 16 that are displaceable in holes 17 through the respective girder. The studs 16 can be pushed inward from the shown position so that they will protrude on the inside of the respective girder. The studs are placed in the longitudinal direction so that they, in that direction, are located right opposite a hole each in one of the container corners. The two middle studs are intended to be projectable into the corners at the ends of the containers facing each other when the container unit consists of three 20 ft containers. The studs 16 are provided with actuators, e.g., electric or hydraulic, and are remote-controlled via electric and hydraulic lines, respectively. This may be effected manually, or automatically triggered by a handling step in the container handling device. The studs are actuated simultaneously. The actuation system may be formed so that the middle ones of the studs 16 are not actuated when the container handling device is used for a 40 ft container.

On each girder on the long side of the grip frame, there are corresponding studs 18 arranged in holes 19 in the girder. Their function and actuation are of the same kind as described above for the studs 16 of the support frame.

In the following, the unloading is described in an example where each container unit consists of two longitudinally arranged 20 ft containers, i.e., when the crane works with twin lifts. In essence, the described applies naturally also to single lifts of a 40 ft container.

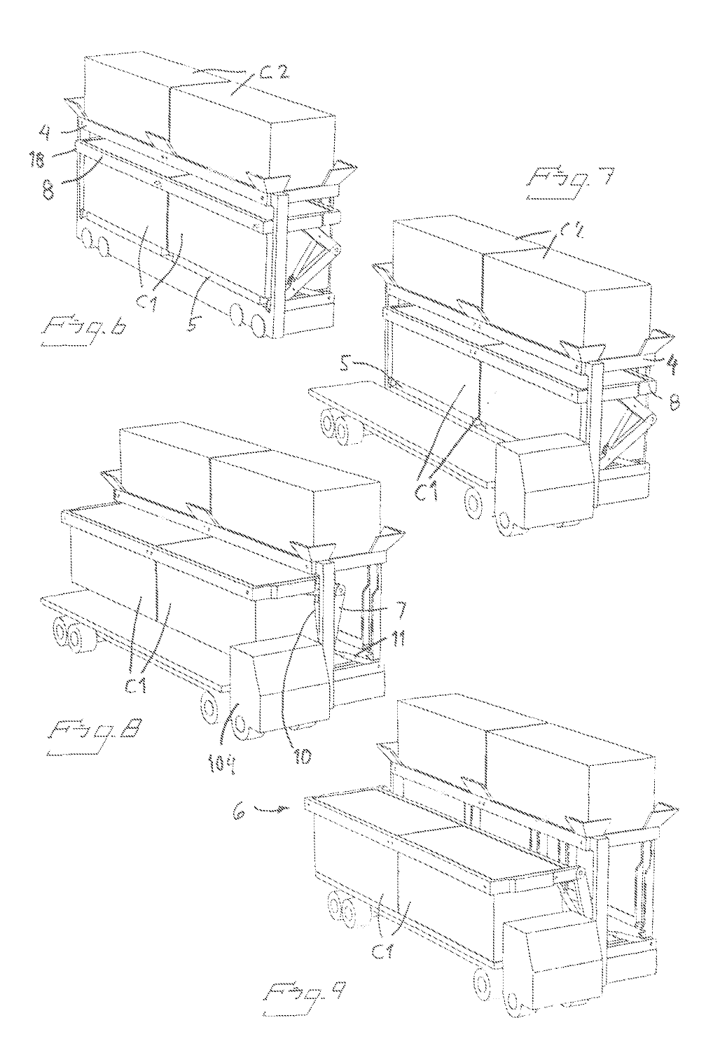

FIG. 3 illustrates the first step of the unloading process. Here, the crane has discharged two container units C1 and C2 on top of each other by a vertical tandem lift. Indeed, the container handling device could receive the container units in separate lifts.

The lower container unit C1 rests on the loading platform 5 that is in its lowermost position. The locking units that are fastened to the underside of the lowermost container unit protrude down into the recesses 12 in the loading platform 5. These are then accessible and can be locked up.

FIG. 4 illustrates the next step, where the loading platform 5 has been elevated a distance and has thereby lifted up both container units C1 and C2. The elevation of the loading platform 5 is adapted so that the uppermost container unit C 2 will be situated with the holes in its lower container corners right opposite a respective stud 16 of the support frame 4. When the loading platform 5 is elevated, the unlocked locking units come loose from the underside of the lower container unit C1. In this position, the studs 16 are displaced into the holes in the container corners, which is illustrated in FIG. 5.

The locking units that connect the two container units can now be locked up so that they are released from the upper side of the lower container unit C1, but they still hang on at the underside of the upper container unit C2.

As is illustrated in FIG. 6, the loading platform 5 is after that lowered, the lower container unit C1 moving along downward. The upper container unit C2 stays carried by the studs 16 of the support frame 4. The grip frame 8 is positioned so that the studs 18 thereof are on a level with the holes in the upper container corners of the lower container unit C1.

In the next step, illustrated in FIG. 7, the studs of the grip frame 8 are inserted into the holes of the lower container unit.

Next, the lower container unit C1 is ready to be unloaded from the container handling device over to a lorry 104, which is illustrated in FIG. 8. This is effected by the link mechanism 7 and hydraulic pistons 10, 11 of the transfer device 6, the front of the container unit C1 being lifted somewhat and then moved laterally out through the front side of the container handling device to the lorry 104.

In FIG. 9, the transfer device 6 has placed the container unit C1 on the lorry platform, and in FIG. 10, it is unloaded onto the platform by the studs of the grip frame 8 being retracted from the holes of the container corners so that the container unit C1 clears the grip frame.

At the same time as the lower container unit C1 is unloaded onto the lorry, the loading platform 5 of the container handling device is elevated and is, in the figure, on its way up toward the upper container unit C2.

In FIG. 11, the grip frame 8 has been lifted somewhat from the container unit C1 on the lorry in order to begin the return movement inward toward the container handling device. Simultaneously, the loading platform 5 has reached the underside of the upper container unit C2 and the studs 16 of the support frame 4 have been disengaged from the corners of the upper container unit C2 so that the same rests on the loading platform 5.

At the same time as the transfer device 6, as is shown in FIG. 12, is retracted, the loading platform 5 is lowered to its lower end position, the upper container unit C 2 moving along.

In FIG. 13, the grip frame 8 has been positioned around the second container unit C2 in order to, after insertion of the studs 18, lift over this container unit to a new lorry that has advanced into position beside the container handling device. This takes place in the same way as described above for the first container unit C1. However, in this stage, the transfer platform 5 is stationary. When the lifting device after that again has been retracted into the container handling device, this is ready to once again receive two container units, as in FIG. 2.

It should be appreciated that the container handling device may have other dimensions than in the illustrated example. It may, e.g., have a length corresponding to a 20 ft container or dimensions corresponding to any one of the other standardized cargo containers on the market. The example shows a container handling device where two container units are stacked on each other. However, it should be realized that such a one easily can be modified to be able to handle three or more container units on top of each other.

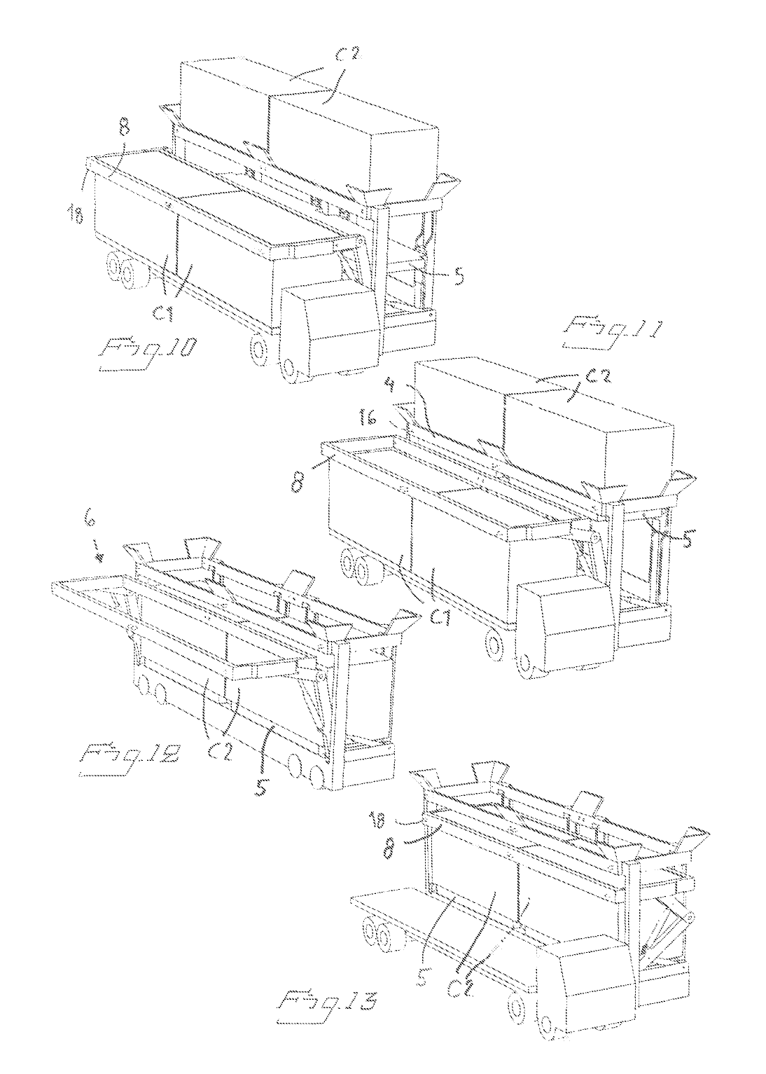

A further example is illustrated schematically in FIG. 14, where the container handling device in principle consists of two sections of the type illustrated in FIGS. 2-13, and that are integrated with the back sides against each other, where each section has a transfer device 6a, 6b and a loading platform 5a, 5b, etc. In this example, container units can be unloaded simultaneously from each section, the unloading taking place outward to a lorry driven up to each long side.

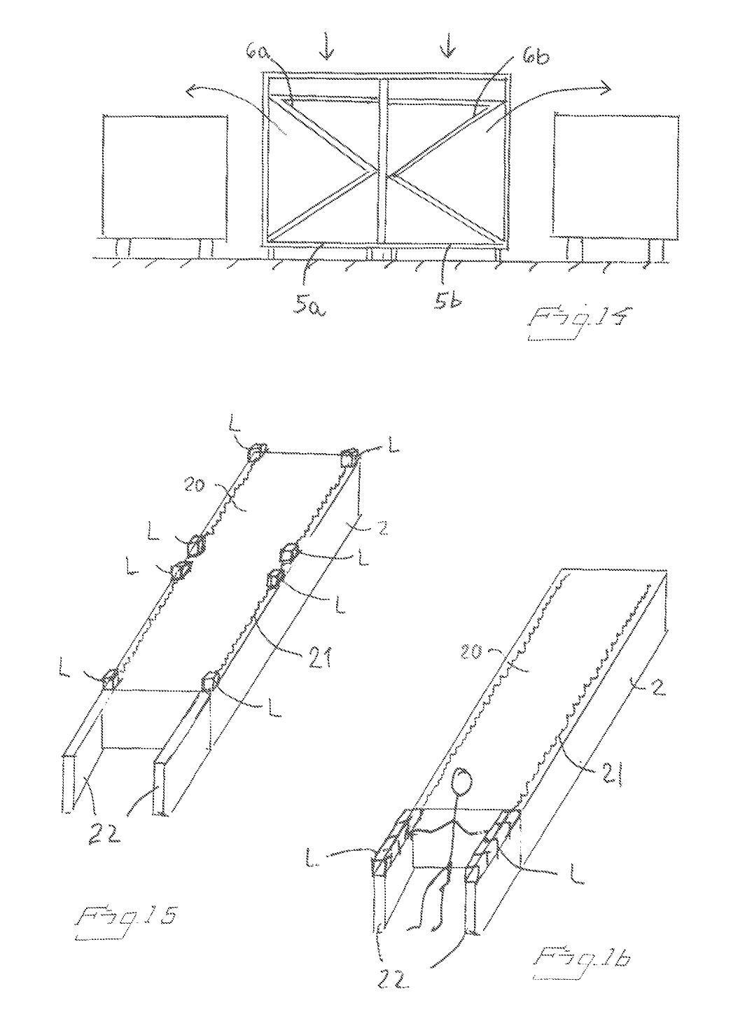

FIGS. 15 and 16 illustrate a further embodiment example wherein coning and deconing are at least partly mechanized.

FIG. 15 is a schematic view of the bottom part 2 of a container handling device, the rest of the container handling device being omitted. On the bottom part, a table 20 is arranged for the handling of the locking units L that have been detached from one of the container units, by means of a device (not shown) at each container corner. A third conveyor transports the detached locking units L from the positions at each container corner out to one short side of the container handling device, where they are collected in a magazine 22 for further transportation away.

FIG. 16 illustrates when the locking units have been collected in the magazine 22.

With a design according to this embodiment example, also coning can be carried out, the locking units being transported out from the magazine 22 by the third conveyor 21 to the positions where they are right opposite a respective container corner.

1. Container handling device for the temporary storage of containers in unloading and loading, wherein the container handling device is arranged to be able to receive at least one pair of container units with one unit in the pair container of units being situated above the other one, which container handling device comprises a support structure, a loading platform connected with the support structure and a transfer device connected with the support structure, which transfer device is arranged to move a container unit laterally, and comprises a laterally moveable grip frame arranged to be able to surround at least three of the vertical side walls of a container unit and which grip frame has inside dimensions that are greater than the cross-sectional dimensions of a container unit in a horizontal plane so that a vertical movement of a container unit through the grip frame is possible.

2. Container handling device according to claim 1, wherein the loading platform is vertically adjustable.

3. Container handling device according to claim 1, wherein the grip frame is arranged to surround all four vertical sides of a container unit.

4. Container handling device according to claim 1, wherein the grip frame is provided with displaceable studs arranged to be insertable into holes situated in corners of the side walls of the container unit.

5. Container handling device according to claim 4, wherein the studs of the grip frame are situated at two long sides of the grip frame and arranged to be insertable into holes situated in upper corners of the two long side walls of a container unit.

6. Container handling device according to claim 4, wherein the number of studs on each long side is two or four.

7. Container handling device according to claim 1, wherein the support structure comprises a support frame, arranged at a height above the loading platform when the loading platform is in its lowermost position, which height exceeds the height of a container unit, which support frame is arranged to be able to surround at least three of the vertical side walls of a container unit and has inside dimensions that are greater than the cross-sectional dimensions of a container unit in a horizontal plane so that a vertical movement of a container unit through the support frame is possible.

8. Container handling device according to claim 7, wherein the support frame is provided with displaceable studs arranged to be insertable into holes situated in corners of the two long side walls of a container unit.

9. Container handling device according to claim 1, wherein the container handling device is provided with lock handling means for the detachment or fastening of locking devices (L) from/to a container unit situated in the container handling device.

10. Container handling device according to claim 9, wherein the container handling device is provided with lock transportation means for the transportation of locking devices (L) from and/or to the respective lock handling means.

11. Container handling device, wherein the container handling device is composed of two adjacent sections, each section formed in accordance with claim 1, each transfer device being arranged to move a container unit in one section laterally in the direction away from the other section.

12. Use of a container handling device according to claim 1, wherein it is used to receive and forward container units in loading and unloading of such ones, preferably also for the detachment and/or attachment of locking devices from to the container units.

13. Method in the unloading of containers from a vessel to a land transportation vehicle by means of a container handling device, comprising the following steps A-E in mentioned order:
A. placing of a first container unit in the container handling device, by a vertical unloading;
B. placing of a second container unit straight above the first container, by a vertical unloading;
C. discharging sideward of the first container unit from the container handling device by means of a laterally moveable grip frame;
D. lowering of the second container unit from the container handling device; and
E. discharging sideward of the second container unit from the container handling device by means of said grip frame.

14. Method according to claim 13, wherein steps A and B are carried out simultaneously by the container units being unloaded from a vertical tandem lift.

15. Method according to claim 13, wherein, in step B, the second container unit is placed so that it rests on the first one.

16. Method according to claim 13, wherein, between steps B and C, the following steps are carried out:
B1. elevation of both container units;
B2. retaining of the second container unit; and
B3. lowering of the first container unit.

17. Method according to claim 13, wherein, in step D, the second container unit is lowered by means of a loading platform arranged in the container handling device.

18. Method in the loading of containers on a vessel by means of a container handling device, comprising the following steps F-J in mentioned order:
F. charging from the side of a first container unit in the container handling device, by means of a laterally moveable grip frame;
G. elevating the first container unit in the container handling device;
H. charging from the side of a second container unit by means of said grip frame;
I. vertical unloading of the first container unit; and
J. vertical unloading of the second container unit.

19. Method according to claim 18, wherein, in step G, the first container unit is elevated by means of a loading platform arranged in the container handling device.

20. Method according to claim 18, wherein, between steps G and H the first container unit is retained, and between steps H and I the first container unit is lowered until it rests on the second container unit.

21. Method according to claim 18, wherein steps I and J take place simultaneously by a vertical tandem lift.

22. Method according to claim 13, wherein locking devices are detached or attached from/to each container unit when the container unit is in the container handling device.

23. Method according to claim 22, wherein locking devices are transported by lock transportation means from/to locking device positions on the container unit.

24. Method according to claim 13, wherein the method is exercised by a container handling device for the temporary storage of containers in unloading and loading, wherein the container handling device is arranged to be able to receive at least one pair of container units with one unit in the pair container of units being situated above the other one, which container handling device comprises a support structure, a loading platform connected with the support structure and a transfer device connected with the support structure, which transfer device is arranged to move a container unit laterally, and comprises a laterally moveable grip frame arranged to be able to surround at least three of the vertical side walls of a container unit and which grip frame has inside dimensions that are greater than the cross-sectional dimensions of a container unit in a horizontal plane so that a vertical movement of a container unit through the grip frame is possible.
